(19) United States
(12) Patent Application Publication
(10) Pub. No.: US 2011/0247567 A1
(43) Pub. Date: Oct. 13, 2011

(54) Animal Shelter

(75) Inventor: Chiu Kwan Chan, Pok Fu Lam (HK)

(73) Assignee: PINTA INTERNATIONAL, LLC

(21) Appl. No.: 12/758,281

(22) Filed: Apr. 12, 2010

(51) Int. Cl. A01K 1/00

(52) U.S. Cl. 119/416

(57) ABSTRACT

The present invention provides an easily-assembled, robustly-constructed animal shelter comprising front, back and side panels with corner columns connecting the side panels to the front and rear panels. A roof includes at least one roof panel that connects to upper ledges of the front and rear panels or the side panels. The prefabricated animal shelter can be assembled and disassembled efficiently by following a series of easy-to-follow steps and be disassembled and reassembled multiple times over the lifetime of the shelter without experiencing significant wear and tear. In addition, the animal shelter is attractive, provides a good deal of interior space for an animal, and may be manufactured and configured in many different embodiments and sizes.

### STATEMENT REGARDING FEDERALLY SPONSORED RESEARCH OR DEVELOPMENT

This invention was made without the support of the Federal Government.

### FIELD OF THE INVENTION

The present invention relates to a shelter for a dog or other animal where the shelter is easily-assembled yet robust, and can be disassembled and reassembled multiple times for cleaning and moving while maintaining its structural integrity and attractive appearance.

### BACKGROUND OF THE INVENTION

In the following discussion, certain animal shelters will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

Conventional animal shelters are available in different sizes, shapes, and materials, and differ in the way in which they are manufactured and assembled. One type of conventional animal shelter or doghouse is one that is built from “scratch” using nails and other non-removable permanent fasteners for connecting the walls and roof. Building an animal shelter from scratch involves a good deal of time and effort for planning and construction. Such an animal shelter is usually limited by a lack of mobility once the house is built.

Other types of conventional animal shelters are prefabricated, made in one or two pieces (e.g., a body separate from a roof). Depending on the materials with which this type of shelter is constructed, the shelter may be robust; however, these types of shelters typically require a large amount of space to store and/or transport due to bulkiness, particularly if the shelter provides a large amount of interior space.

Other types of prefabricated shelters known in the art comprise front, back and side panels with a roof and may not require an excessive amount of space to store; however, structures where the panels are connected directly to one another are not entirely stable and are less flexible in terms of overall structure configuration.

To date, animal shelters have been constructed primarily from wood or plastic. Wood shelters can be quite robust; however, wood shelters are subject to rot, they are expensive if high quality lumber is used, and they require re-finishing to maintain an attractive appearance. Further, wood is neither easily cleaned nor is it easy to fabricate into complex connector elements. Plastic shelters, on the other hand, are more easily cleaned and the components are easier to fabricate; however, plastic structures typically have a less attractive appearance, do not have the structural integrity of wood, and even the best plastics will eventually break down when exposed to UV light from the sun and to precipitation and temperature fluctuations. Moreover, colored plastic is subject to fading.

What has not been available until now is a sturdy and reliable prefabricated animal shelter that can be assembled and reassembled without excessive wear and tear and that can be stored and transported using a minimal amount of space, yet is attractive, robust, and provides a large amount of interior space when assembled. The present invention meets this unmet need.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description including those aspects illustrated in the accompanying drawings and defined in the appended claims.

Thus, in one embodiment, the present invention provides an animal shelter comprising: a plurality of side panels, a front panel and a rear panel; and a plurality of corner columns that connect the side panels, front panel and rear panel to one another, wherein each side panel, front panel, and rear panel comprises an interior wall, a top edge, a bottom edge and two ends. In addition, each end of each side panel, front panel, and rear panel includes at least one key connector with which to engage a keyhole connector in a corner column or wherein each end includes at least one keyhole connector with which to engage a key connector in a corner column. Also, the animal shelter comprises at least one roof panel, wherein each roof panel includes at least two roof fasteners attached to its interior surface that slidably connects to connectors on at least two of the side panels, the front panel or the rear panel.

In some aspects of the present invention, the corner columns of the animal shelter comprise at least two slots, with at least one keyhole or key disposed within each slot, and where the ends of the wall panels slidably engage within the slots.

In other aspects of the present invention, the side, front, back and roof panels and the corner columns comprise wood/plastic composite. In some embodiments the wood/plastic composite comprises from about 37 to about 45 percent wood and from about 57 to about 63 percent plastic.

Also in some embodiments, the animal shelter comprises one or more floor panels, and in some embodiments, there are one or more structural supports under the one or more floor panels.

In some aspects of the present invention, reversible locks are provided for the key and keyhole connections.

In some embodiments of the present invention, there are two roof panels, and in yet other aspects of the present invention, where there are two roof panels there is a roof peak that fits into a juncture between the two roof panels.

In yet other aspects of the present invention, one or more of the plurality of side panels, the front panel, the rear panel, the one or more floor panels or the one or more roof panels comprise structural supports, and in other aspects of the present invention, one or more of the plurality of side panels, the front panel, the rear panel, the one or more floor panels or the one or more roof panels comprise insulation.

In yet other embodiments, the present invention provides an animal shelter comprising: a plurality of side panels, a front panel and a rear panel; a plurality of corner columns that connect the side panels, front panel and rear panel to one another, wherein each side panel, front panel, and rear panel comprises an interior wall, a top edge, a bottom edge and two ends and wherein each end includes at least one connector with which to engage a connector in a corner column. In addition, one or more floor panels and at least one roof panel are provided wherein each roof panel includes at least two roof fasteners attached to the interior surface of each roof panel that slidably connects to connectors on at least two of the side panels, the front panel or the rear panel; where the side panels, front panel, rear panel, floor panel, at least one roof panel comprise wood/plastic composite.

In yet other embodiments, the present invention provides an animal shelter comprising: a plurality of side panels, a front panel and a rear panel; and a plurality of corner columns that connect the side panels, front panel and rear panel to one another, where each side panel, front panel, and rear panel comprises an interior wall, an exterior wall, a top edge, a bottom edge and two ends and wherein each end includes at least one key with which to engage a keyhole in a corner column or wherein each end includes at least one keyhole with which to engage a key in a corner column. Embodiments also include one or more floor panels; and one or more roof panels, where each roof panel includes at least two roof fasteners attached to the interior surface of each roof panel that slidably connects to connectors on at least two of the side panels, the front panel or the rear panel.

### DESCRIPTION OF THE FIGURES

FIG. 1 is a perspective view of an assembled animal shelter according to one embodiment of the present invention.

FIG. 2 is an exploded perspective view of an assembled animal shelter according to one embodiment of the present invention.

FIG. 3 is another perspective view of an assembled animal shelter body (the roof is not shown) according to one embodiment of the present invention, viewed from above the animal shelter.

FIG. 4 is a perspective view of a corner column and a side panel according to one embodiment of the present invention, showing the detail of one key and keyhole connector.

FIGS. 5 (a) and (b) show a front perspective view and a cross-sectional view of a side panel of the animal shelter according to one embodiment of the present invention.

FIGS. 6 (a), (b) and (c) are front perspective views showing the assembly of first and second roof panels and a roof peak of the animal shelter shown in FIGS. 1 and 2.

FIGS. 7 (a), (b) and (c) are perspective views of assembled animal shelters according to three alternative embodiments of the present invention.

### DETAILED DESCRIPTION OF THE INVENTION

In the following description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention.

The present invention provides an easily-assembled, robustly-constructed animal shelter or doghouse comprising, front, back and side panels (collectively, “wall panels”), with corner columns connecting the side panels to the front and rear panels. A roof includes, in one embodiment, two roof panels that connect to upper ledges of the front and rear panels where the two roof panels are supported by the side panels. In other embodiments of the animal shelter of the present invention, a single roof panel may be employed. Where two roof panels are employed, a roof peak is optionally employed, located where the roof peak joins the two roof panels and reliably seals the roof. The prefabricated animal shelter can be assembled and disassembled efficiently by following a series of easy-to-follow steps, and can be disassembled and reassembled multiple times over the lifetime of the shelter without experiencing significant wear and tear. In addition, the animal shelter of the present invention provides a great deal of interior space for an animal, and may be manufactured and configured in many different embodiments and sizes.

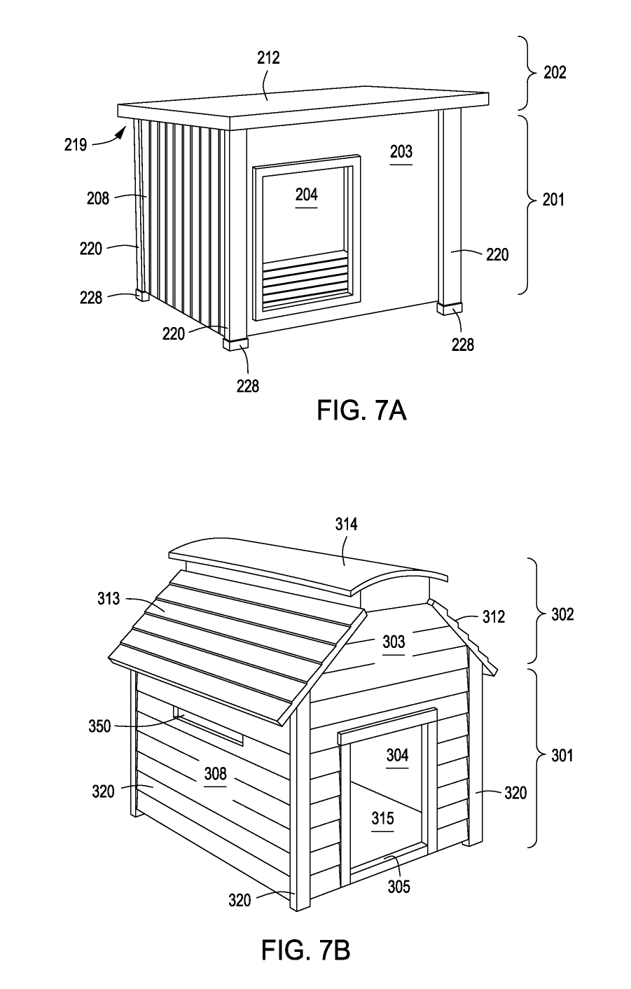

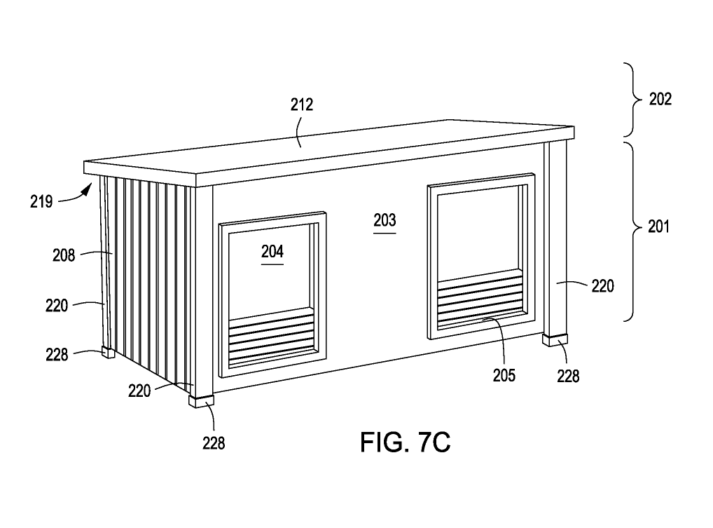

The animal shelters of the present invention are made of a wood/plastic composite. The advantages of using wood/plastic composites are numerous, not the least of which such composites provide the attractive appearance of wood with the flexibity of manufacture of plastics. Wood/plastic composites permit manufacture of an animal shelter that is low cost, lightweight, and can utilize eco-friendly, recycled materials. The animal shelters of the present invention have the attractiveness of wood structures which allows them to blend into their surrounds, yet such composite structures do not possess the disadvantages of wood. Wood/plastic composite is strong and inexpensive, in addition, wood/plastic composite retains its structural integrity over long periods of time, does not rot or need refinishing and is easily cleaned. Wood/plastic composite can be painted, sawed, and drilled like wood, yet molded like plastic. Moreover, use of wood/plastic composite allows one to use a molding process for fashioning the various components of the animal shelter, which results in very low cost manufacturing, quality consistency and production efficiency. Because wood/plastic composite may be molded, various components of the shelter—for example the corner columns in the illustrated embodiments—may have a complex design that would be extremely difficult to fashion in wood. The complex design of, for example, the corner columns allows for a great deal of flexibility in the design of the animal shelter; for example, the shelter components may be modular and allow for more complex structures to be built (for example, see the animal shelter illustrated in FIG. 7 (c)), and the shelter may be designed to allow for, e.g., ventilation by designing one or more wall panels to be sectional.

Wood/plastic composites employed in the present invention are known in the art. Preferably, such composites comprise from about 35 to about 65 percent wood and from about 35 to about 65 percent polymer. More preferably, the wood/plastic composites comprise from about 35 to about 50 percent wood and from about 55 to about 65 percent plastic. Even more preferably, the wood/plastic composites comprise from about 37 percent to about 45 percent wood and from about 57 to about 63 percent plastic. In some preferred embodiments, the wood is untreated poplar and the plastic is polyvinylchloride. In addition to wood and plastic, the wood/plastic composite may further comprise UV protectants, stabilizers, coloring agents, binding agents and/or resins, and the like.

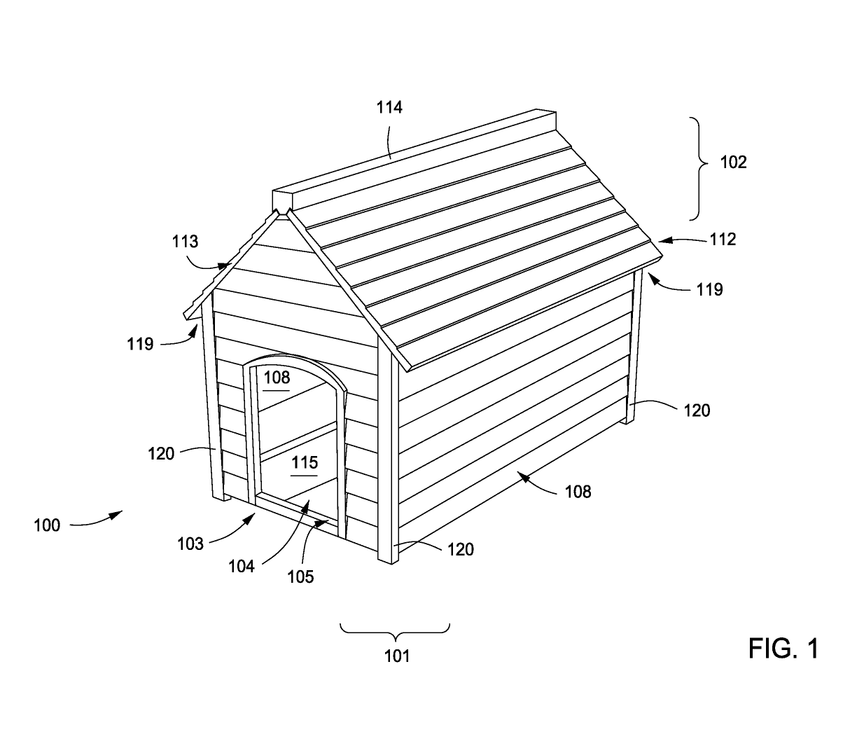

FIGS. 1 through 7 illustrate embodiments of collapsible, prefabricated animal shelters according to the present invention. The animal shelters include a plurality of wall, roof and floor panels and corner columns that interconnect quickly and conveniently to form a durable and reliable structure. Additionally, the components of the shelter can be disassembled quickly and, since each panel is relatively flat, the panels may lay atop one another in a neat and efficient manner for storage or transport. Each wall panel is constructed to releasably interlock with corner columns and to abut one or more roof panels to form the shelter. In the embodiments of the present invention shown in FIGS. 1-7 (a) and 7 (b), there are a total of four wall panels comprising two side panels, one front panel and one rear panel. FIG. 7 (c) illustrates an embodiment where there are five wall panels, comprising two side panels, one front panel, one rear panel, and one interior panel bisecting the interior of the shelter. The exterior surfaces of the front, back and side panels are, optionally, patterned to give the appearance of slats that are aligned adjacent to one other such as would be the case with a wooden structure. FIGS. 1-6 and 7(b) illustrate shelters employing two roof panels, and FIGS. 7 (a) and 7 (c) illustrate shelters employing a single roof panel. It should be apparent given the teachings and illustrations herein that many different shelter types and configurations may be designed.

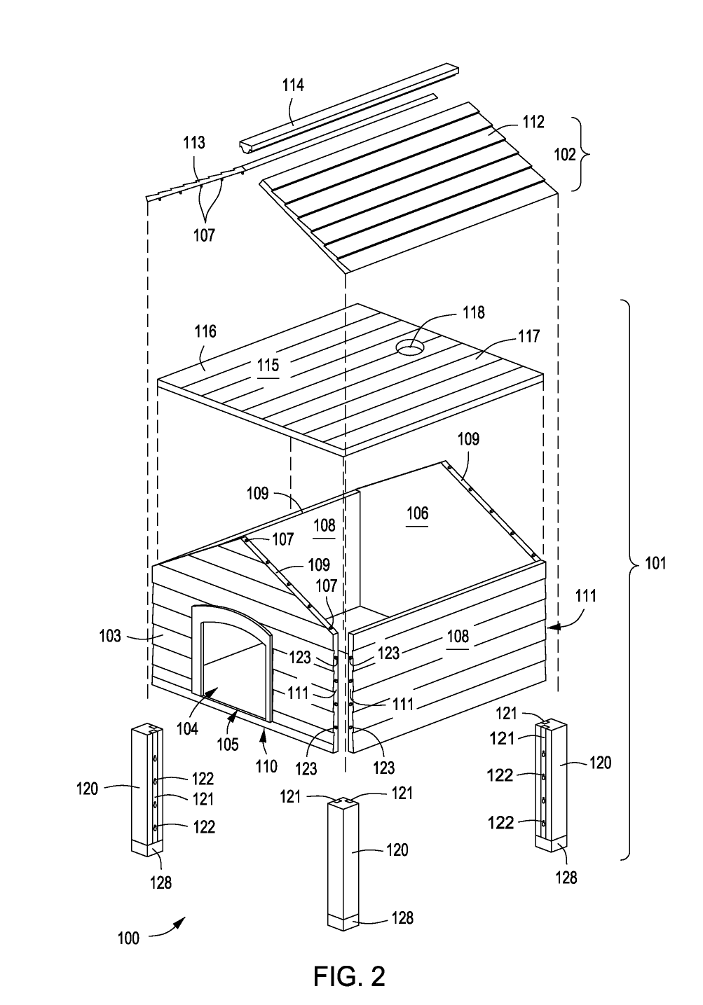

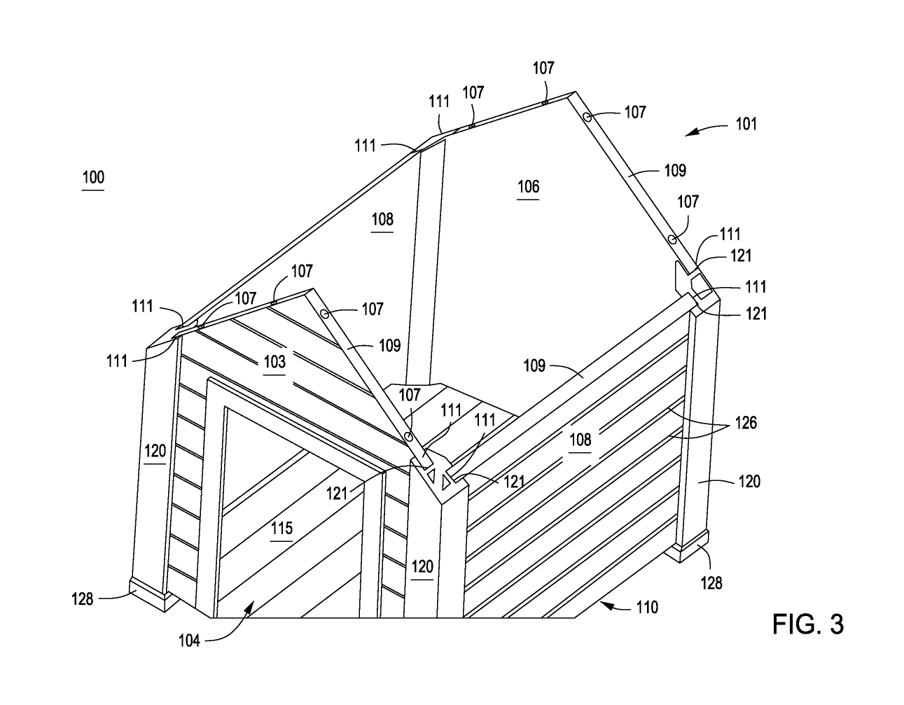

FIGS. 1-6 show one embodiment of a collapsible, prefabricated animal shelter 100, according to one embodiment of the present invention. FIGS. 1 and 2 illustrate the embodiments of shelter 100 generally, while FIGS. 3-6 illustrate details of certain aspects of this embodiment.

FIG. 1 is a perspective view of the assembled animal shelter 100. The animal shelter includes a body 101 supporting a roof 102. The body 101 includes a front panel 103, a rear panel (not shown), side panels 108, a floor panel 115, and four corner columns 120 (only three can be seen in this perspective figure). Disposed within front panel 103, there is a door 104 and a threshold 105 of door 104. The roof 102 includes a first roof panel 112, a second roof panel 113, and a roof peak 114. According to this embodiment of the invention, the roof 102 is shaped in an inverted V-shape that extends from the front panel 103 to the rear panel. The roof 102 also forms eaves 119 by extending forward past the front panel 103 and rearward past the rear panel, and over the side panels 108.

FIG. 2 is an exploded perspective view of an assembled animal shelter 100. Animal shelter 100 includes a body 101 supporting a roof 102. The body 101 includes corner columns 120, a front panel 103, a rear panel 106, side panels 108, and a floor panel 115. The front panel 103 comprises a door 104 having a threshold 105. Also, all wall panels have one or more connectors—in this embodiment keys 123—at their ends 111, that connect through slots 121 that extend longitudinally from a top position to a bottom position in the corner columns 120 with keyholes 122 disposed within the slots 121 to reversibly join the panels to one another via the corner columns 120. In FIG. 2, only the keys 123 on the ends 111 of front panel 103 and one side panel 108 are shown. In addition to the slots 121 and keyholes 122, the corner columns 120 also comprise bottoms 128 which support the animal shelter 100 on the ground, and are adjacent to the bottom 110 of each panel.

Also seen in FIG. 2, floor panel 115 comprises a front 116, a rear 117, and optionally a drain hole 118, which, if present, is optionally located to the rear of the animal shelter 100. Though a single floor panel is seen in FIG. 2, the floor panel can optionally comprise two or more panels, particularly in larger structures. In some embodiments, the one or more floor panels may comprise cut-out corners to accommodate the intrusion into the interior space of the shelter by the corner columns, if so configured (an example of this embodiment is shown in FIG. 3). Also, in some embodiments, one or more supports may be present under the one or more floor panels, where such supports may be bars connected to opposing wall panels. For example, in a large animal shelter, two or three steel bars may be secured to side walls 108 before the one or more floor panels 115 are placed into the shelter 100. If present, such supports are secured within the shelter structure before the one or more floor panels are placed into position.

Roof 102 in this embodiment includes a first roof panel 112, a second roof panel 113, and a roof peak 114. Again, according to one embodiment of the invention, the roof 102 is shaped in an inverted V-shape. The roof 102 also forms eaves (not shown) by extending forward past the front panel 103, rearward past the rear panel 106 and over-hanging the side panels 108. Roof 102 also comprises roof fasteners 107 that connect, in this embodiment, with roof fasteners 107 on the tops 109 of front panel 103 and the rear panel 106.

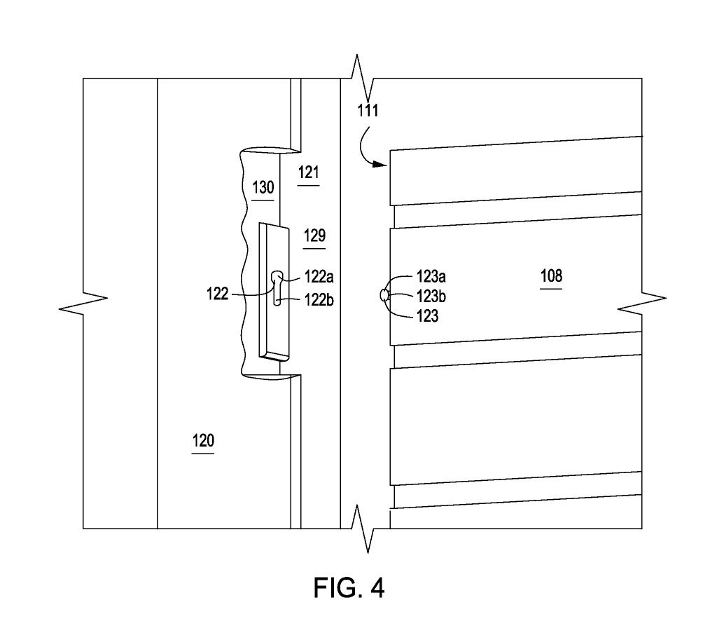

FIG. 3 is another perspective view of an assembled animal shelter body 101 (roof 102 is not shown), viewed from above the animal shelter 100. In FIG. 3, front panel 103 and back panel 106 are connected to both side panels 108 via corner columns 120. Slots 121 in the corner column 120 receive the ends 111 of each panel. Disposed within slots 121 are connectors 122 (not seen in FIG. 3 but described in detail in FIG. 4), preferably keyholes, that connect with connectors 123 (preferably keys) on the ends 111 of each panel. In addition, roof fasteners 107, such as sliding clips or other equivalent fasteners are seen disposed on the top edges 109 of front panel 103 and rear panel 106. Also seen, floor panel 115 positioned within the shelter body 101 (note the cut out corner of the floor panel 115 accommodates the corner column), door 104 formed in front panel 103 and bottom edge 110 of side panel 108.

FIG. 4 is a perspective view of a corner column 120 and a side panel 108, showing the detail of one key 123 and one keyhole 122 connector. In FIG. 4, part of the wall of corner column 120 that forms slot 121 has been cut away so that only one side wall 129 and the back wall 130 of slot 121 is seen. Keyhole connector 122 is disposed on the back wall 130 of slot 121. Key 123 is disposed on the end 111 of side panel 108. Key 123 has a knob portion 123a and a stem portion 123b. In this embodiment, knob portion 123a may be inserted into the top 122a of keyhole 122, then side wall 108 is pushed down so that the knob portion 123a of key 123 inserts within the bottom 122b of keyhole 122. The bottom 122b of keyhole 122 has a back portion adjacent back wall 130 of slot 121 and a front portion that will abut the end 111 of side panel 108 once side panel 108 is in place. The back portion of the bottom 122b of keyhole 122 is large enough to receive the knob portion 123a of key 123; however, the front portion of the bottom 122b of keyhole 122 is narrower than the knob portion 123a of key 123 but is wide enough to receive the stem portion 123b of key 123. In addition, in some embodiments the opening of the keyhole can be tapered front to back to increase the tight fit of the key within the keyhole. The key/keyhole connection is made—joining a corner column 120 to a front, side or rear panel—by first inserting the knob portion 123b of key 123 in the top 122a of keyhole 122, then sliding the key 123 down into the bottom 122b of keyhole 122.

The key and keyhole connection described herein provides a tight, robust yet reversible connection between corner columns 120 and the front, rear and side panels, allowing the corner columns 120 and the front, rear and side panels to be easily disassembled by lifting the front, rear or side panels to lift the knob portion 123b of the keys 123 into the top 122a of keyhole 122, and pulling the panel away from the corner column. The key/keyhole connector configuration described herein is a preferred connector system for the present invention, because the keys and keyholes may be easily fashioned using wood/plastic composite. Alternatively, the keys and keyholes may be made of metal or other material and secured to the corner columns and wall panels via ordinary hardware. The present Figure shows key 123 on end 111 of the wall panels, and the keyhole 122 disposed within the slot 121 of corner column 120; however, in alternative embodiments, key 123 is disposed within the slot 121 of corner column 120, and the keyhole 122 is on the end 111 of the front, rear and side panels. In addition, the key/keyhole connectors can be reversibly locked into place.

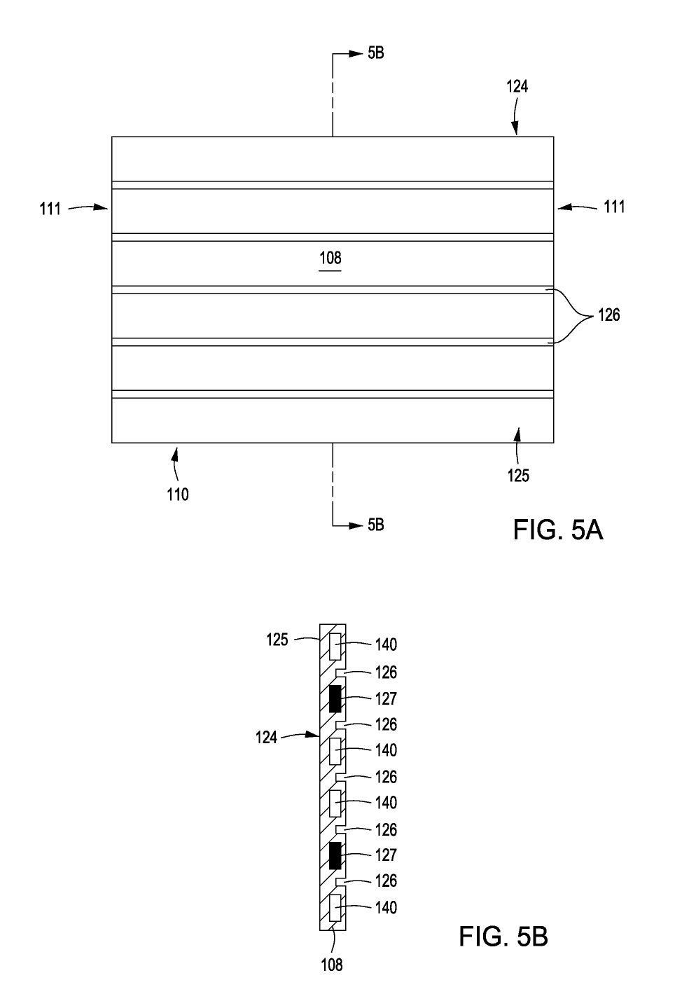

FIG. 5 (a) shows a front perspective view and FIG. 5 (b) shows a cross-sectional view of a side panel 108 of the animal shelter 100 (seen in FIGS. 1 and 2), though it should be recognized that the features described could also apply to the front and rear panels, one or more roof panels or one or more floor panels of the shelter. FIG. 5 (a) shows side panel 108 with an interior face 124 that forms a wall of the interior of the animal shelter, an exterior face 125, a bottom 110 and two ends 111. As seen in FIG. 4, the ends 111 of side panel 108 will connect with the corner columns (not seen) when the shelter is assembled. Also seen in FIG. 5 (a) are a plurality of lateral recesses 126 on the exterior face 125 of side panel 108, to provide an exterior face that resembles a wooden structure composed of slats. FIG. 5 (b) is a cross-sectional view of a side panel 108, taken along line 5B-5B. As seen in this perspective, the interior face 124 of side panel 108 is smooth, and the exterior face 125 of side panel 108 has a plurality of recesses 126 which give the animal shelter, when assembled, the appearance of a slatted wooden structure.

In addition, the embodiment of a side panel in FIG. 5 (b) shows side panel 108 that optionally comprises additional structural supports or reinforcements 127, which run laterally through side panel 108. Because the animal shelter of the present invention is composed of wood/plastic composite, the front, rear, and side panels, as well as the roof and floor panels are primarily hollow molded composite (see voids 140 in the side panel 108 in FIG. 5B) except for structural supports or struts 127 that may be present to increase structural integrity. In FIG. 5 (b), two such structural supports are shown; however, none, one, two, three or more structural supports may be used depending on the size of the shelter. Structural supports may be used in each panel used to build the shelter (including wall, floor and roof panels), or in less than all of the panels. Typically, the larger the shelter, the more structural supports are used. In a preferred embodiment, at least one structural support is used in each wall panel of the shelter, as well as in each roof panel of the shelter. In a preferred embodiment, the structural supports are made of steel due to steel's light weight, low cost and reinforcement properties; however, the structural supports may be formed of additional wood/plastic composite, an appropriate metal alloy or some other material. In such an embodiment, the steel or other structural element is sandwiched within the molded wood/plastic composite panel.

Also in some embodiments of the animal shelter of the present invention insulation may be disposed within any one or all of the front, rear, side, roof and floor panels in the hollow portions of the molded panels (see, for example, voids 140 in side panel 108 in FIG. 5 (b)). Insulating materials are known in the art; however, in preferred embodiments, eco-friendly and/or all-natural materials such as perlite are used.

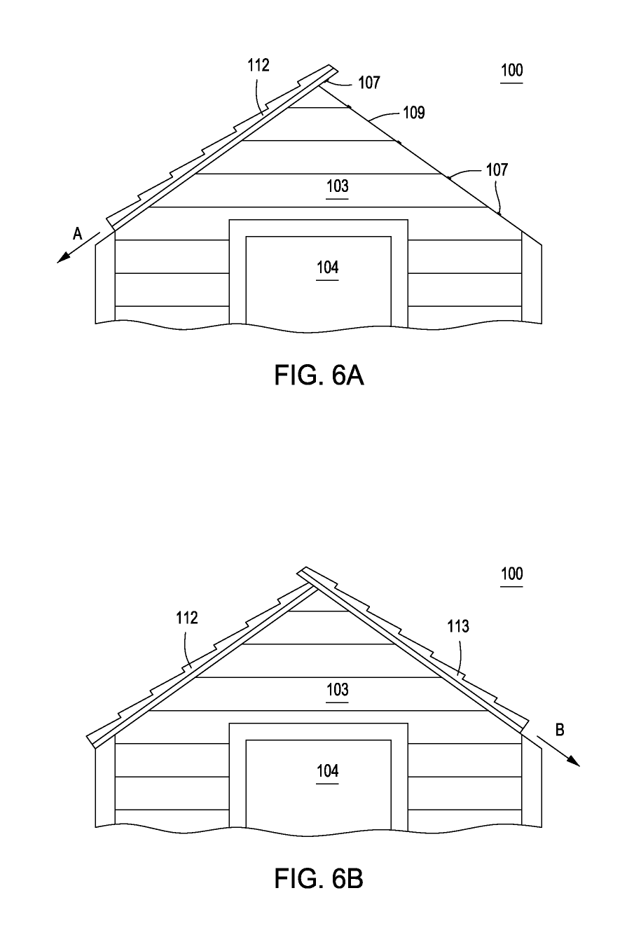

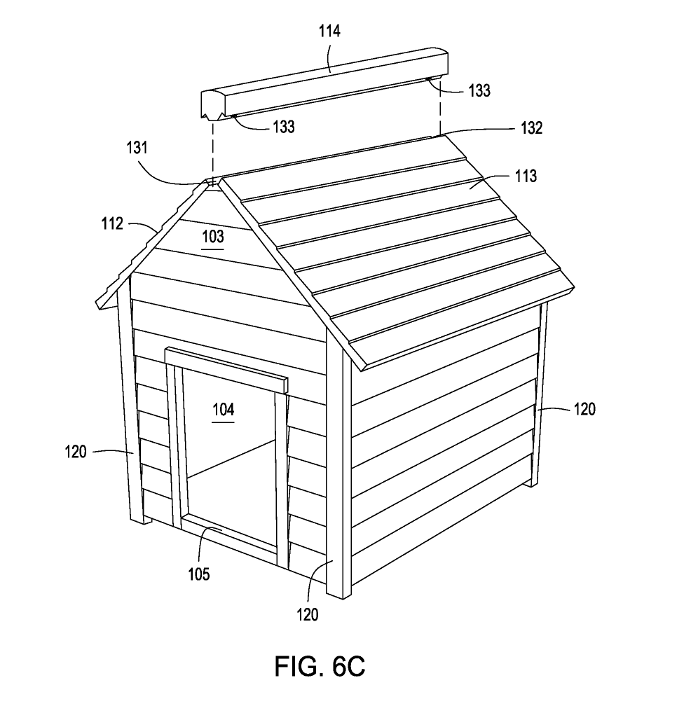

FIGS. 6 (a), (b) and (c) are front perspective views showing the assembly of the first and second roof panels and the roof peak of the animal shelter shown in FIGS. 1 and 2. FIG. 6 (a) shows the front of animal shelter 100, with front panel 103 and the door 104 of the animal shelter. A first roof panel 112 is

[symbol]

FIG. 6 (b) shows the next step in the process of assembling the roof 102 where the first roof panel 112 is in place and the second roof panel 113 is being mounted by sliding the second roof panel 113 in the direction along arrow B. FIG. 6 (c) shows a final step in the process of assembling the roof 102 where the first roof panel 112 and second roof panel 113 are in place, and the roof peak is to be lowered and then slid along the interface of first roof panel 112 and second roof panel 113. The roof peak may be secured to the first and second roof panels in any number of ways, for example, the roof peak and the first and second roof panels may have compatible hardware pre-mounted such as rails along both sides of the length of the roof peak that fits within tracks disposed on the lengths of the first and second roof panels at the intersection of the roof panels. Alternatively, in a preferred embodiment, the peak portions 131 and 132 of the front panel 103 and rear panel 106, respectively, may have fasteners, such as keys or keyholes, that mate with fasteners 133 such as keyholes or keys on the bottom of roof peak 114. In addition, the roof peak optionally may comprise two end caps that are placed on either end of the roof peak once it has been secured to the first and second roof panels.

Regarding the animal shelter generally, if fasteners of the type shown in the previous Figures and described herein are employed, all connectors on the animal shelter are secured to the structural components of the animal shelter; that is, (1) the key and keyhole connectors for the corner columns and the wall panels are secured to or integral with the corner columns and wall panels, (2) the sliding clip roof connectors are secured to the tops of the front and rear panels and to the bottoms of the first and second roof panels, and (3) the roof peak and the one or more roof panels comprise keys and keyholes secured thereon. Such a self-contained configuration has several advantages. First, separate hardware is not needed to assemble the animal shelter; thus, there are no small components that can get lost in shipping or misplaced during disassembly. Second, no tools are required to assemble the animal shelter. In some embodiments, separate hardware optionally may be employed, particularly in the form of pegs or key/keyhole locks which help to secure and stabilize the animal shelter.

Assembly of the animal shelter is straightforward, and the process may be inferred by reference to FIG. 2. First, one wall panel at a time is connected to the corner columns by inserting the ends 111 of the wall panels in the slots 121 of the corner columns 120. By doing so, the keys 123 at the ends of the wall panels are aligned with and inserted into the top 122a portion of the keyholes 122. The wall panels are then slid in a downward motion to lock the wall panel into place (the key 123 will slide downward into the bottom 122b portion of the keyhole 122, as described in FIG. 4). Once each wall panel has been attached to two corner columns to form the basic shape of the animal shelter (typically rectangular), the floor panel support(s), if present, and the floor panel(s) are installed by placing the panel(s) through the top of the structure and fitting the panel(s) into place. Next, as shown in FIGS. 6 (a), (b) and (c), the roof connectors (sliding clips) of the first roof panel 112 are aligned with the roof connectors on the top edge 109 of the front panel and the rear panel. First roof panel 112 is then slid downward allowing the connectors to engage and lock into place. Next, the roof connectors (sliding clips) of the second roof panel 113 are aligned with the roof connectors on the top edge 109 of the front panel and the rear panel and the second roof panel 112 is then slid downward allowing the connectors to engage and lock into place. Finally, the roof peak 114 is lowered onto the interface between the first roof panel 112 and the second roof panel 113 and slid so that the fasteners 133 (keys or keyholes) on the bottom of the roof peak 114 can engage with the keyholes or keys at the peak 131 of the front wall panel 103 and the peak 132 of the rear wall panel 106.

Alternative embodiments to the animal shelter seen in FIGS. 1-6 are illustrated in FIGS. 7 (a) through (c). For example, the animal shelter need not have a roof with the inverted “V” configuration shown in, e.g., FIGS. 1 and 2. The roof of the animal shelter of the present invention may have essentially any configuration that permits easy assembly, disassembly and storage. For example, the roof may be flat, raised on one side and slanted to the opposite side (such as the configuration shown in FIGS. 7 (a) and (c)), have a gabled appearance (such as the configuration shown in FIG. (b)) and the like. Also, the animal shelter may have more than one interior space, such as the shelter shown in FIG. 7 (c), which can be configured as shown, or by using three-way column connectors in the middle of the shelter that allow for the connection of two rear and front panels as well as a an interior panel.

In addition, one or more of the wall panels may be configured to have an opening for ventilation such as a permanent opening 350 shown in FIG. 7 (b), or one or more wall panels may be split or sectioned longitudinally into two separate portions where one portion of a wall panel can be removed for ventilation, when desired, or where all portions of a wall panel can remain in place when ventilation is not desired. Other embodiments include animal shelters that are raised off the ground, animal shelters that include exterior features such as fencing, porches or decks and/or interior features such as “sleeping lofts” or other horizontal or vertical partitioning of the interior space, and the like.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims. In the claims that follow, unless the term “means” is used, none of the features or elements recited therein should be construed as means-plus-function limitations pursuant to 35 U.S.C. §112, ¶6.

I claim:

1. An animal shelter comprising: a plurality of side panels; a front panel and a rear panel; a plurality of corner columns that connect the side panels, front panel and rear panel to one another, wherein each side panel, front panel, and rear panel comprises an interior wall, a top edge, a bottom edge and two ends and wherein each end includes at least one key connector with which to engage a keyhole connector in a corner column or wherein each end includes at least one keyhole connector with which to engage a key connector in a corner column; and at least one roof panel, wherein each of the at least one roof panels includes at least two roof fasteners attached to an interior surface of each roof panel that slidably connects to connectors on at least two of the side panels, the front panel or the rear panel.

2. The animal shelter of claim 1, wherein the corner columns comprise at least two slots, with at least one keyhole or key disposed within each slot, and wherein the ends of the panels slidably engage within the slots.

3. The animal shelter of claim 1, wherein the side, front, back and roof panels and the corner columns comprise wood/plastic composite.

4. The animal shelter of claim 3, wherein the wood/plastic composite comprises from about 37 to about 45 percent wood and from about 57 to about 63 percent plastic.

5. The animal shelter of claim 1 further comprising one or more floor panels.

6. The animal shelter of claim 5, wherein there are one or more structural supports under the one or more floor panels.

7. The animal shelter of claim 1, further comprising reversible locks for the key and keyhole connections.

8. The animal shelter of claim 1, wherein there are two roof panels.

9. The animal shelter of claim 8, further comprising a roof peak that fits into a juncture between the two roof panels.

10. The animal shelter of claim 1, wherein one or more of the plurality of side panels, the front panel, the rear panel, the one or more floor panels or the one or more roof panels comprises structural supports.

11. The animal shelter of claim 1, wherein one or more of the plurality of side panels, the front panel, the rear panel, the one or more floor panels or the one or more roof panels comprises insulation.

12. An animal shelter comprising: a plurality of side panels; a front panel and a rear panel; a plurality of corner columns that connect the side panels, front panel and rear panel to one another, wherein each side panel, front panel, and rear panel comprises an interior wall, a top edge, a bottom edge and two ends and wherein each end includes at least one connector with which to engage a connector in a corner column; one or more floor panels; and at least one roof panel, each roof panel including at least two roof fasteners attached to an interior surface of each roof panel that slidably connects to connectors on at least two of the side panels, the front panel or the rear panel; wherein the side panels, front panel, rear panel, floor panel, at least one roof panels comprise wood/plastic composite.

13. The animal shelter of claim 12, wherein each end comprises at least one key connector with which to engage a keyhole connector in a corner column or wherein each end comprises at least one keyhole connector with which to engage a key connector in a corner column.

14. The animal shelter of claim 13, further comprising reversible locks for the key and keyhole connections.

15. The animal shelter of claim 12 further comprising one or more floor panels.

16. The animal shelter of claim 12, wherein there are two roof panels.

17. The animal shelter of claim 16, further comprising a roof peak that fits into a juncture between the two roof panels.

18. The animal shelter of claim 12, wherein one or more of the plurality of side panels, the front panel, the rear panel, the one or more floor panels or the one or more roof panels comprises structural supports.

19. The animal shelter of claim 18, wherein one or more of the plurality of side panels, the front panel, the rear panel, the one or more floor panels or the one or more roof panels comprises insulation.

20. An animal shelter comprising: a plurality of side panels; a front panel and a rear panel; a plurality of corner columns that connect the side panels, front panel and rear panel to one another, wherein each side panel, front panel, and rear panel comprises an interior wall, an exterior wall, a top edge, a bottom edge and two ends and wherein each end includes at least one key with which to engage a keyhole in a corner column or wherein each end includes at least one keyhole with which to engage a key in a corner column; one or more floor panels; and one or more roof panels, wherein each roof panel includes at least two roof fasteners attached to an interior surface of each roof panel that slidably connects to connectors on at least two of the side panels, the front panel or the rear panel.
